(19) United States
(12) Patent Application Publication
(10) Pub. No.: US 2008/0122355 A1
(43) Pub. Date: May 29, 2008

(54) Light Bulb Comprising an Illumination Body, Which Contains a Metal Compound that is Stable at High Temperature

(75) Inventors: Axel Bunk, Munchen (DE); Matthias Damm, Gaimersheim (DE); Georg Rosenbauer, Wassertrudingen (DE)

Correspondence Address: OSRAM SYLVANIA INC, 100 ENDICOTT STREET, DANVERS, MA, 01923, US

(73) Assignee: PATENT TREUHAND GESELLSCHAFT, Munchen (DE)

(21) Appl. No.: 11/666,095

(22) PCT Filed: Dec. 1, 2005
(86) PCT No.: PCT/DE05/02170

§ 371 Date: Apr. 24, 2007

(30) Foreign Application Priority Data
Dec. 8, 2004 (DE) 10 2004 059 174.1

(51) Int. Cl. H01K 1/50

(52) U.S. Cl. 313/578

(57) ABSTRACT

A light bulb (1), equipped with an illumination body (7), which is enclosed together with a filler (2) in a vacuum in a bulb. The illumination body (7) includes a metal carbide, whose melting point lies above that of tungsten. The bulb also contains carbon, hydrogen and fluorine, preferably in combination.

### TECHNICAL FIELD

The invention is based on a light bulb having an illumination body which contains a metal compound that is stable at high temperature, according to the preamble of claim 1. These are in particular light bulbs with a carbide-containing illumination body, and the invention relates particularly to halogen light bulbs which comprise a TaC illumination body or whose illumination body contains TaC as a constituent or coating.

### PRIOR ART

One known option for increasing the efficiency of light bulbs is to use incandescent bodies made of ceramics with high melting points, such as tantalum carbide. See for example Becker, Ewest: “Die physikalischen und strahlungstechnischen Eigenschaften des Tantalkarbids” [The physical and radiation properties of tantalum carbide], Zeitschrift für technische Physik, No. 5, pp. 148-150 and No. 6, pp. 216-220 (1930)). The increase in efficiency is due to the fact that the metal carbide incandescent body can be operated at higher temperatures owing to the much higher melting points compared with pure metals: the melting point for TaC is 3880° C. as opposed to 3410° C. for tungsten. Furthermore, compared with tungsten, the emission coefficient of carbides in the visible range is greater than in IR. In particular, tantalum carbide is a better “selective radiator” than tungsten.

One problem when operating tantalum carbide illumination bodies at high temperatures is constituted by decarburization; this leads to the formation of subcarbides with a higher resistivity and lower melting point, and therefore to rapid destruction of the illumination body. In order to resolve this problem, there are many approaches in the literature.

One possibility, mentioned in U.S. Pat. No. 3,405,328, consists in dissolving carbon in excess in the tantalum carbide illumination body. The carbon evaporating outward from the illumination body, which deposits on the bulb wall, is then replaced by diffusion from the inside.

Adding carbon and hydrogen to the filling gas constitutes another possibility, see for example U.S. Pat. No. 2,596,469. A carbon cycle process is thereby set up in the light bulb. The carbon evaporating at high temperatures reacts at lower temperatures with hydrogen to form hydrocarbons, which are transported back by convection and/or diffusion to the illumination body where they re-decompose. The carbon thereby released accumulates again on the illumination body. For a functional carbon cycle process, it is usually necessary to employ a hydrogen excess in order to prevent carbon from depositing (in the form of carbon black) in the light bulb vessel. When using methane or ethene, for example, the partial pressure of hydrogen must be greater by about a factor of 2 than that of the hydrocarbon. Otherwise, carbon will be deposited in the light bulb vessel. Since the necessary concentrations of carbon and hydrogen must usually lie in the range of up to a few percent, the high proportion of hydrogen has a detrimental effect on the efficiency of the light bulb.

In order to reduce the efficiency loss, halogens besides hydrogen are also used for reaction with the carbon, see for example U.S. Pat. No. 3,022,438. The carbon evaporating from the illumination body reacts in the cool regions near the bulb wall, for example with chlorine atoms to form compounds such as CCl₄, so that carbon is prevented from depositing on the wall. The carbon-halogen compounds are transported back in the direction of the incandescent body by transport processes such as convection and diffusion, and they decompose in the hotter region to release carbon. The carbon can accumulate again on the filament. In order to prevent carbon from depositing by using halogen and hydrogen, according to U.S. Pat. No. 3,022,438 both the amount of the halogen element introduced overall into the light bulb and the amount of the element hydrogen must each be greater than the amount of carbon present overall in the gas phase. Since the carbon-chlorine and carbon-bromine compounds can be formed only at temperatures around or below about 150° C., application of the carbon-halogen cycle process is restricted to light bulbs with a relatively large bulb volume and therefore bulb temperatures around or below 200° C. The carbon-halogen cycle process based on chlorine or bromine no longer functions reliably at temperatures of at least 200° C. and with correspondingly small dimensions of the bulb. Another disadvantage with using halogens, to prevent carbon from depositing on the bulb wall, is that the constituents of the framework or the filament in the cooler regions are attacked by the relatively large halogen concentrations required for this.

With relatively high operating temperatures of the TaC illumination body, evaporation of tantalum (Ta) also takes place to a lesser extent besides the evaporation of carbon (C), see for example J. A. Coffmann, G. M. Kibler, T. R. Riethof, A. A. Watts: WADD-TR-60-646 Part I (1960). It has therefore proven expedient for a further cycle process, for recycling tantalum to the illumination body, to be superimposed on a cycle process for recycling carbon to the illumination body, see DE-A 103 56 651. For example, accumulation of carbon on the bulb wall can be avoided by using hydrogen, and that of tantalum by using halogens such as chlorine or bromine or iodine. It is nevertheless also possible to use other elements.

An exception in respect of employing halogens is constituted by the use of fluorine compounds. In principle, fluorine is outstandingly suitable for the formation of a fluorine cycle process because carbon-fluorine compounds are stable up to temperatures far above 2000 K, see Philips techn. Rdsch. 35, 228-341. No. 11/12. Therefore, on the one hand blackening of the bulb wall is efficiently prevented, and on the other hand carbon is expediently transported back to the hottest position of the illumination body (regenerative cycle process). Such a carbon-fluorine cycle process is usable both for light bulbs with illumination bodies made of carbon and with illumination bodies made of metal carbides. A disadvantage, however, is that the bulb wall must to this end be protected against attack by fluorine, see U.S. Pat. No. 3,022,438 (Cooper, Use of F in TaC light bulbs). It may perhaps also be necessary to protect the parts of the framework. Owing to the concomitant outlay, the fluorine cycle process has not to date been employed on a large scale.

### SUMMARY OF THE INVENTION

It is an object of the present invention to provide a light bulb having an illumination body which contains a metal compound that is stable at high temperature, and in particular a carbide-containing illumination body, according to the preamble of claim 1, which permits a long lifetime and overcomes the problem of the illumination body becoming depleted of an evaporating component. It is a further object to optimally utilize the effect of fluorine.

These objects are achieved by the characterizing features of claim 1. Particularly advantageous configurations can be found in the dependent claims.

The term “metal compound that is stable at high temperature” means compounds whose melting point lies close to the melting point of tungsten, sometimes even above. The material of the illumination body is preferably TaC or Ta₂C. Carbides of Hf, Nb or Zr are nevertheless suitable as well, as are alloys of these carbides. Also nitrides or borides of such metals. A property which these compounds have in common is that an illumination body made of this material becomes depleted of at least one element during operation.

If an illumination body is operated at high temperatures, then—depending on the constitution of the material of the illumination body—evaporation of material or constituents of the material takes place. The evaporated material or its constituents are transported away for example by convection, diffusion or thermodiffusion, and are deposited at another position in the light bulb, for example on the bulb wall or framework parts. The evaporation of the material or its constituents leads to rapid destruction of the illumination body. The transmission of light is greatly reduced by material depositing on the bulb wall.

### EXAMPLES

(a) The tungsten evaporated from an incandescent filament made of tungsten in a conventional light bulb is transported to the bulb wall, where it is deposited.

(b) A tantalum carbide illumination body operated at high temperatures decomposes to form the brittle subcarbide Ta₂C that melts at lower temperatures than TaC, and gaseous carbon which is transported to the bulb wall where it is deposited.

The object is to minimize or reverse evaporation from the illumination body by suitable measures.

It has been found that employing fluorine can be useful even in light bulbs with illumination bodies made of a metal carbide and—in contrast to the aforementioned applications relating to fluorine compounds—an unprotected bulb made of glass (for example quartz, hard glass), if it is used besides hydrogen and optionally a further halogen. If a filling gas, containing a hydrocarbon and hydrogen besides the inert gas, is additionally dosed with a fluorine compound, then a favorable effect is achieved in respect of preventing the bulb from being blackened and of extending the lifetime. Fluorine may, for example, be dosed in the form of CF₄ or fluorinated hydrocarbons, such as CF₃H, CF₂H₂, C₂F₄H₂ etc. These compounds decompose at high temperatures to release fluorine. The reaction of fluorine on the bulb wall releases oxygen or oxygen compounds such as CO at least in small amounts, which is evidently not problematic if the amount of oxygen released is limited. The amount of oxygen thereby released must be less than the amount of carbon and the hydrogen which is present. Together with the fluorine compounds present in the gas phase, the oxygen thereby released has a favorable effect. This favorable effect is not however attributable to a carbon-fluorine cycle process as described for example in Philips techn. Rdsch. 35, 228-341. No. 11/12, since, at temperatures close to the bulb wall, fluorine is in no case still available for the formation of carbon-fluorine compounds such as CF₄, but instead the great majority of it is bound as SiF₄. Rather, this favorable effect is attributable to a combined effect of oxygen and the SiF₄ released in the wall reaction.

If the metal carbide illumination body is operated at higher temperatures, then a further halogen such as chlorine or bromine or iodine must be added besides fluorine in order, as per the yet unpublished DE-A 103 56 651.1, to prevent tantalum from being deposited on the bulb wall and to transport it back to the illumination body. In virtually all practically relevant cases, this is necessary because precisely in order to improve the efficiency, the illumination body is operated at relatively high temperatures significantly above 3000 K. Fluorine is not available for this cycle process, since it has reacted on the bulb wall to form SiF₄.

The favorable effect of fluorine can be further enhanced if metals such as iron, cobalt, nickel or even molybdenum are used in the cooler regions at temperatures usually around 150° C. to 400° C. These metals probably act as catalysts as per Fischer-Tropsch reactions, the carbon monoxide reacting with hydrogen on the catalyst to form hydrocarbons and water. The otherwise very stable carbon monoxide molecule is therefore re-decomposed, and both carbon and oxygen are resupplied to the reaction mechanism. The hydrocarbon decomposes on its way to the illumination body while releasing carbon, which can accumulate again on the illumination body. The released oxygen reacts directly with the carbon transported up from the illumination body to form carbon monoxide. Since this reaction—in contrast to the reaction of carbon with hydrogen—already takes place at much higher temperatures, blackening of the bulb is thereby effectively prevented. The metals acting as catalysts should preferably be used at as low as possible a temperature, in order to avoid a reaction with the halogen used for the tantalum cycle process.

The difference of the procedure described here, for example from that described in U.S. Pat. No. 3,022,438 or DE 1 188 201, is that the glass walls are deliberately not protected and furthermore the amount of the halogen fluorine and of the further halogen (chlorine, bromine, iodine) is selected to be much less than that of carbon. The difference from the procedure described in DE-A 103 24 361 is that the light bulb is not filled with any oxygen compound, rather the oxygen is released from the material of the bulb wall, and on the other hand the operation is not halogen free, rather fluorine as well as at least one further halogen are used in order to improve the lifetime and reduce the blackening of the bulb.

In respect of the dosing, the following ratios may be defined. The molar concentration of carbon should be greater at least by a factor of 3, preferably by a factor of from 5 to 40, in particular from 5 to 20, than the molar concentration of fluorine. The molar concentration of hydrogen should be greater at least by a factor of 4, preferably by a factor of from 5 to 40, than that of carbon. The molar concentration of the further halogen, needed for recycling the tantalum to the illumination body, should be less than half the hydrogen concentration and preferably less than one tenth of the hydrogen concentration.

As a guideline, the following concentrations are found for a cold filling pressure of 1 bar. The molar concentration of carbon should lie between 0.1% and 5%. The molar concentration of the further halogen (chlorine, bromine, iodine) needed for the tantalum cycle process should lie between 500 ppm and 5000 ppm. All other concentrations are then obtained by calculation with the ratios specified above. Conversion to other cold filling pressures is obtained using the constraint that the number of particles contained overall in the light bulb volume should be constant. When converting from 1 to 2 bar, the individual concentrations are therefore to be halved.

There is an exception when using iodine if, for example as described in DE-A 103 56 651, this is used for binding hydrogen in order to prevent it from permeating through the bulb wall. Much larger molar concentrations of iodine are then used, which correspond to a factor of up to 5, preferably a factor of up to 2, of the amount of hydrogen used.

The dosing of the individual constituents may be carried out as follows:

Carbon is added via optionally halogenated hydrocarbons such as CH₄, C₂H₂, C₂H₄, C₂H₆, CF₄, CH₂Cl₂, CH₃Cl, CH₂Br₂, CF₃Br, CH₃I, C₂H₅I, CF₃C₁, CF₂BrCl, etc., in which case the additionally required halogens may simultaneously be dosed via the halogenated hydrocarbons.

Hydrogen is added either via optionally halogenated hydrocarbons (see above) or via hydrogen gas H₂.

Fluorine is added via the aforementioned at least partially fluorinated hydrocarbons, fluorine F₂, NF₃, PF₃, etc.

Bromine, chlorine, iodine (halogen for the Ta cycle process) are added via the aforementioned at least partially halogenated hydrocarbons, for example CH₂Br₂, CH₃Br, CH₃Cl, CCl₄, additionally via Br₂, Cl₂, I₂, and it is also possible to use PCl₃, PBr₃, etc.

One very specific mixture is:

1 bar Kr+1% CH₄+3% H₂+0.1% CF₂Br₂

The bulb consists of glass with a high melting point, which is intended to mean hard glass, Vycor or quartz glass. A suitable hard glass is for example borosilicate glass, in particular aluminoborosilicate glass, or aluminosilicate glass, in particular alkaline-earth aluminosilicate glass.

The present invention is suitable in particular for low-tension light bulbs with a voltage of at most 50 V, because the illumination bodies needed therefor can be made relatively sizeable and the wires for this preferably have a diameter of between 50 μm and 300 μm, in particular at most 150 μm for general lighting purposes with a maximum power of 100 W. Thick wires of up to 300 μm are used in particular for photo-optical applications up to a power of 1000 W. The invention is particularly preferably used for single-pinch light bulbs, since in this case the illumination body can be kept relatively short so that the susceptibility to breakage is likewise reduced. Nevertheless, application is also possible for double-pinch light bulbs and light bulbs for mains voltage operation.

The term rod as used here in refers to a means which is designed as a solid rod, or in particular as a thin wire.

### BRIEF DESCRIPTION OF THE DRAWINGS

The invention will be explained in more detail below with the aid of several exemplary embodiments.

FIG. 1 shows a light bulb having a carbide illumination body according to one exemplary embodiment;

FIG. 2 shows a light bulb having a carbide illumination body according to a second exemplary embodiment;

FIGS. 3 to 6 show a light bulb having a carbide illumination body according to further exemplary embodiments.

### PREFERRED EMBODIMENT OF THE INVENTION

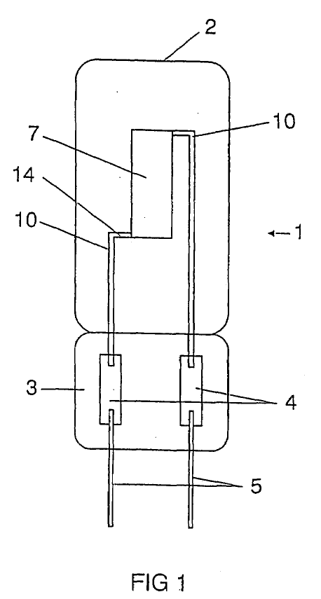

FIG. 1 shows a single-pinch light bulb 1 having a bulb made of quartz glass 2, a pinch seal 3 and inner electrodes 10, which connect foils 4 in the pinch seal 3 to an illumination body 7. The illumination body 7 is a singly wound, axially arranged wire made of TaC, whose ends 14 are unwound and stand transversely to the light bulb axis. The outer leads 5 are attached externally to the foils 4.

The design described here may for example also be adapted to light bulbs having illumination bodies made of other metal carbides, for example hafnium carbide, zirconium carbide, niobium carbide. It is also possible to use alloys of different carbides. The use of borides or nitrides, in particular rhenium nitride or osmium boride, is furthermore possible.

In general, the light bulb preferably uses an illumination body made of tantalum carbide, which preferably consists of a singly coiled wire. Zirconium carbide, hafnium carbide, or an alloy of different carbides as described for example in U.S. Pat. No. 3,405,328, is also preferably suitable as an illumination body material, which is preferably a coiled wire.

The bulb is typically made of quartz glass or hard glass with a bulb diameter of between 5 mm and 35 mm, preferably between 8 mm and 15 mm.

The filling is primarily an inert gas, in particular a noble gas such as Ar, Kr or Xe, optionally with the admixture of small amounts (up to 15 mol %) of nitrogen. A hydrocarbon, hydrogen and a halogen additive comprising fluorine are typically added to this.

A halogen additive is expedient irrespective of possible carbon-hydrogen cycle processes or transport processes, in order to prevent the metal evaporated from the metal carbide illumination body from being deposited on the bulb wall and to transport it back as much as possible to the illumination body. This involves a metal-halogen cycle process as described for example in the application DE-No. 103 56 651.1. In particular, the following fact is important: the more the evaporation of carbon from the illumination body can be suppressed, the less is the evaporation of the metallic components as well, see for example J. A. Coffmann, G. M. Kibler, T. R. Riethof, A. A. Watts: WADD-TR-60-646 Part I (1960).

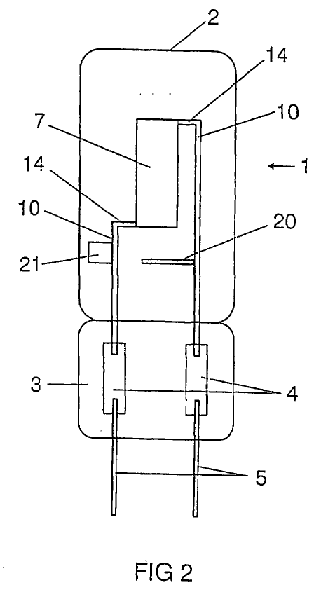

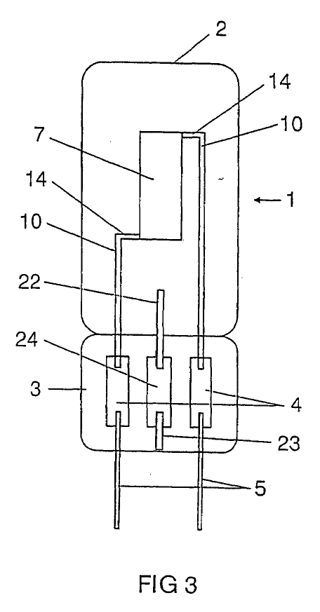

FIG. 2 is essentially constructed similarly to FIG. 1. A catalyst is additionally used here, which is welded for example in the form of wires 20 or platelets 21 onto the parts of the framework or the filament connection. An alternative (FIG. 3) consists in welding the wire 22 onto a third Mo foil 24 in the pinch seal 3. A holder made of molybdenum for the additional foil 24 is denoted by 23. As an alternative, parts of the framework could be made directly from the material of the catalyst. It is also possible to coat the connections or parts of the framework with the material of the catalyst. As already mentioned, metals such as iron, nickel, cobalt or molybdenum, but also rhodium or rhenium, are suitable as catalysts.

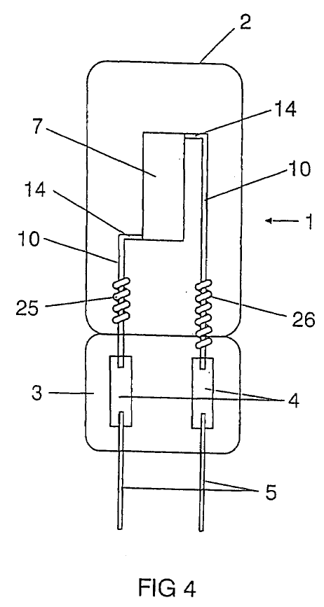

FIG. 4 schematically shows an example in which the catalyst is formed by overcoat windings 25 on the inner electrodes. They are made, for example, of nickel. The overcoat windings may even be extended into the pinch seal, see the right-hand side (26).

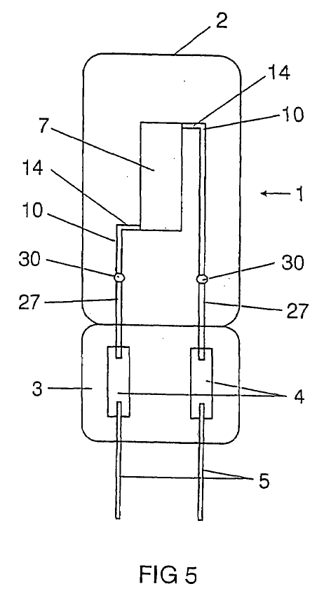

FIG. 5 shows an exemplary embodiment in which the catalyst is formed by configuring the lower parts of the inner electrodes separately. They are formed by wires 27 of catalyst material, in particular molybdenum. The upper parts 28 of the inner electrode are made of tungsten. The two parts are connected together by weld points 30.

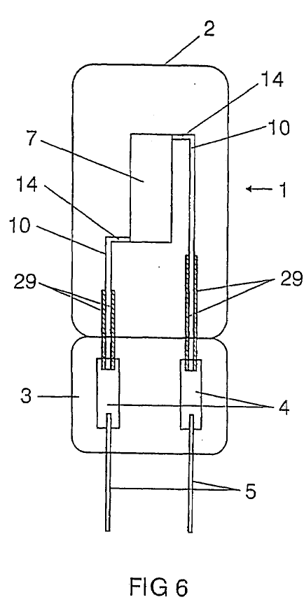

Lastly, FIG. 6 shows catalysts which are produced as a coating 29 on the lower parts of the electrodes 10. The coating extends into the pinch seal 3.

The fluorine compounds referred to here are generally gaseous. They are co-introduced into the bulb when filling, and they decompose in a short time. The catalyst described here is used for the purpose of making it possible to cleave CO.

Contrasting with this is a concept which adopts continuous provision of carbon by using a solid that contains fluorine. CF4 or the like is then evaporated continuously. In this case the carbon is transported straight back to the hottest position of the illumination body by carbon-fluorine compounds, i.e. here the fluorine is directly important for the carbon transport, in contrast to the concept described in this document. A catalyst used therein acts as a sink for carbon throughout the lifetime.

The inner electrodes together form the framework. In particular, the filament connections may be used directly as constituents of the framework.

1. A light bulb having an illumination body which contains a metal compound that is stable at high temperature (7) and having electrodes (10) which hold the illumination body (7), the illumination body being introduced vacuum-tightly together with a filling in a bulb (2), the material of the illumination body comprising a metal carbide whose melting point lies close to the melting point of tungsten, and having a bulb which consists of glass with a high melting point, characterized in that the filling simultaneously contains the three components carbon, hydrogen and fluorine, the filling being in direct contact with at least a part of the inner wall of the bulb and the carbon being introduced as a compound.

2. The light bulb as claimed in claim 1, characterized in that the illumination body is enclosed by a bulb made of quartz glass, Vycor or hard glass.

3. The light bulb as claimed in claim 1, characterized in that the filling uses a base gas in the form of an inert gas, in particular noble gas and/or nitrogen.

4. The light bulb as claimed in claim 1, characterized in that at least one of the components hydrogen and fluorine is introduced into the bulb as a compound.

5. The light bulb as claimed in claim 4, characterized in that all three compounds are introduced into the bulb as compounds.

6. The light bulb as claimed in claim 4, characterized in that at least one other halogen from the group Cl, Br, I is introduced into the bulb as a compound.

7. The light bulb as claimed in claim 1, characterized in that the illumination body is a coiled wire or a strip, which consists of tantalum carbide at least on its surface.

8. The light bulb as claimed in claim 1, characterized in that the illumination body consists of ZrC, HfC or an alloy of these carbides, the alloy preferably containing TaC, the illumination body being in particular a coiled wire.

9. The light bulb as claimed in claim 1, characterized in that the illumination body consists of a core and a coating on its surface, the core being in particular a rhenium wire or a carbon fiber, or a bundle of carbon fibers, with the coating consisting of carbide.

10. The light bulb as claimed in claim 1, characterized in that the molar concentration of carbon is greater at least by a factor of 3, preferably by a factor of from 5 to 40, than the molar concentration of fluorine, and in that the molar concentration of hydrogen is greater at least by a factor of 4, preferably by a factor of from 5 to 40, than that of carbon.

11. The light bulb as claimed in claim 6, characterized in that the molar concentration of the further halogen needed for recycling the tantalum to the illumination body is less than half the hydrogen concentration and preferably less than one tenth of the hydrogen concentration.

12. The light bulb as claimed in claim 6, characterized in that expressed in terms of a cold filling pressure of 1 bar, the molar concentration of carbon lies between 0.1% and 5%, the molar concentration of the further halogen needed for the tantalum cycle process lying between 500 ppm and 5000 ppm.

13. The light bulb as claimed in claim 1, characterized in that the illumination body is connected to electrodes, a metallic catalyst being fastened on at least one electrode so that the metal acting as a catalyst is exposed to a temperature in the range of between 100° C. and 600° C. during operation of the light bulb.

14. The light bulb as claimed in claim 13, characterized in that the catalyst is a piece of wire, a platelet or a coil.

15. The light bulb as claimed in claim 13, characterized in that the catalyst is applied as a coating on at least one electrode.

16. The light bulb as claimed in claim 1, characterized in that the molar concentration of carbon lies between 0.1% and 5%, expressed in terms of a cold filling pressure of 1 bar.

17. The light bulb as claimed in claim 2, characterized in that the illumination body is a coiled wire or a strip, which consists of tantalum carbide at least on its surface.

18. The light bulb as claimed in claim 2, characterized in that the illumination body consists of ZrC, HfC or an alloy of these carbides, the alloy preferably containing TaC, the illumination body being in particular a coiled wire.

19. The light bulb as claimed in claim 2, characterized in that the illumination body consists of a core and a coating on its surface, the core being in particular a rhenium wire or a carbon fiber, or a bundle of carbon fibers, with the coating consisting of carbide.

20. The light bulb as claimed in claim 2, characterized in that the molar concentration of carbon is greater at least by a factor of 3, preferably by a factor of from 5 to 40, than the molar concentration of fluorine, and in that the molar concentration of hydrogen is greater at least by a factor of 4, preferably by a factor of from 5 to 40, than that of carbon.
